(19) United States
(12) Patent Application Publication
(10) Pub. No.: US 2022/0330053 A1
(43) Pub. Date: Oct. 13, 2022

(54) SLEEPING CELL DETECTION

(71) Applicant: Elisa Oyj, Helsinki (FI)

(72) Inventors: Mika SAVELA, Helsinki (FI); Henri KARIKALLIO, Helsinki (FI)

(73) Assignee: Elisa Oyj, Helsinki (FI)

(21) Appl. No.: 17/620,924

(22) PCT Filed: Jun. 9, 2020
(86) PCT No.: PCT/FI2020/050401

§ 371 Date: Dec. 20, 2021

(30) Foreign Application Priority Data
Jun. 26, 2019 (FI) 20195562

(51) Int. Cl. H04W 24/04

(52) U.S. Cl. CPC H04W 24/04

(57) ABSTRACT

A computer implemented method of sleeping cell detection in a communication network. Performance indicator values of cells of the communication network are monitored and one or more of the following events are detected in a cell: no downlink data event, wherein it is detected that data is being transmitted in uplink direction and no data is being transmitted in downlink direction; no data transmission event, wherein requests to open data connections are detected and it is detected that no data is being transmitted in uplink or downlink direction; sudden traffic drop event, wherein it is detected that there is a sudden decrease in the amount of data traffic in the cell; and abnormal distribution event, wherein it is detected that data traffic distribution between uplink and downlink directions is abnormal. Responsively the cell is determined to be a sleeping cell.

### TECHNICAL FIELD

The present application generally relates to sleeping cells in communication networks.

### BACKGROUND

This section illustrates useful background information without admission of any technique described herein representative of the state of the art.

A sleeping cell of a communication network is in general a cell that is seemingly operating as it should, but data connections are not working properly. The problem exists especially in 2G networks, but the problem has been identified also in other networks. A sleeping cell does not trigger conventional alarms of communication networks and thus is difficult to detect.

US2010234006 provides one solution for detecting sleeping cell in a telecommunications network. The solution is to configure user equipment, UE, to detect an existence of a potentially sleeping cell. The UE informs the radio network controller, RNC, about the potential sleeping cell and the RNC confirms the status prior to corrective actions.

Now a different solution is provided.

### SUMMARY

Various aspects of examples of the disclosed embodiments are set out in the claims. Any devices and/or methods in the description and/or drawings which are not covered by the claims are examples useful for understanding the disclosed embodiments.

According to a first example aspect of the present disclosure, there is provided a computer implemented method of sleeping cell detection. The method comprises

monitoring performance indicator values of cells of the communication network;

detecting one or more of the following events in a cell:
no downlink data event, wherein it is detected that data is being transmitted in uplink direction and no data is being transmitted in downlink direction,
no data transmission event, wherein requests to open data connections are detected and it is detected that no data is being transmitted in uplink or downlink direction,
sudden traffic drop event, wherein it is detected that there is a sudden decrease in the amount of data traffic in the cell, and
abnormal distribution event, wherein it is detected that data traffic distribution between uplink and downlink directions is abnormal; and responsively determining that the cell is a sleeping cell.

In an embodiment, the determination of the cell being a sleeping cell requires that number of detected events exceeds a predefined threshold.

In an embodiment, the method further comprises, responsive to the cell being determined a sleeping cell, performing a corrective action for the cell.

In an embodiment, the method further comprises detecting that the cell remains a sleeping cell after the corrective action being performed for the cell, and responsively performing a corrective action for a base station comprising the cell.

In an embodiment, the method further comprises detecting that the cell remains a sleeping cell after the corrective action being performed for the base station, and responsively performing a corrective action for a base station controller of the cell.

In an embodiment, the corrective action comprises one or more of the following: deactivation and reactivation of data transmission in the cell or in the base station; resetting software in the cell or in the base station; resetting one or more components of the cell or the base station; resetting the whole cell or the whole base station.

In an embodiment, the method further comprises detecting that the cell remains a sleeping cell after one or more corrective actions, and responsively generating a ticket for manual action.

In an embodiment, the method further comprises, responsive to the cell being determined a sleeping cell, deactivating and reactivating data transmission.

In an embodiment, the method further comprises detecting that the cell remains a sleeping cell after the deactivation and reactivation of data transmission, and responsively resetting one or more components of the cell or the base station comprising the cell.

In an embodiment, the method further comprises detecting that the cell remains a sleeping cell after resetting the one or more components, and responsively resetting the whole cell or the whole base station.

In an embodiment, the method further comprises detecting that the cell remains a sleeping cell after resetting the whole cell or the whole base station, and responsively generating a ticket for manual action.

According to a second example aspect of the present disclosure, there is provided an apparatus comprising a processor and a memory including computer program code; the memory and the computer program code configured to, with the processor, cause the apparatus to perform the method of the first aspect or any related embodiment.

According to a third example aspect of the present disclosure, there is provided a computer program comprising computer executable program code which when executed by a processor causes an apparatus to perform the method of the first aspect or any related embodiment.

The computer program of the third aspect may be a computer program product stored on a non-transitory memory medium.

Different non-binding example aspects and embodiments of the present disclosure have been illustrated in the foregoing. The embodiments in the foregoing are used merely to explain selected aspects or steps that may be utilized in implementations of the present disclosure. Some embodiments may be presented only with reference to certain example aspects of the disclosed embodiments. It should be appreciated that corresponding embodiments may apply to other example aspects as well.

### BRIEF DESCRIPTION OF THE DRAWINGS

For a more complete understanding of example embodiments of the present disclosure, reference is now made to the following descriptions taken in connection with the accompanying drawings in which:

FIG. 1 shows an example scenario according to an embodiment;

FIGS. 2-4 show flow diagrams illustrating example methods according to certain embodiments; and

FIG. 5 shows an apparatus according to an embodiment.

### DETAILED DESCRIPTON OF THE DRAWINGS

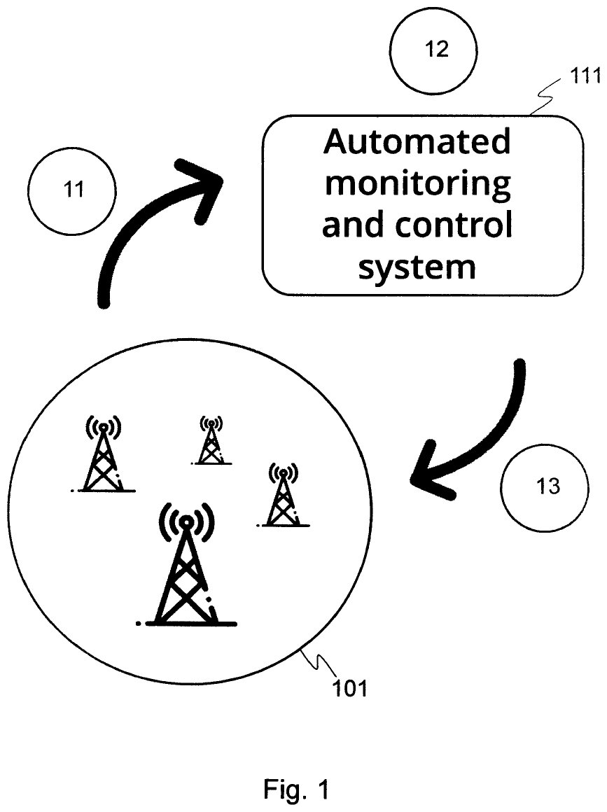

Example embodiments of the present disclosure and its potential advantages are understood by referring to FIGS. 1 through 5 of the drawings. In this document, like reference signs denote like parts or steps.

In an embodiment of the present disclosure there is provided an automated communication network monitoring and control system that is configured to detect sleeping cells in the communication network and optionally provide automatic recovery of the situation. The developed automated solution can be employed in a network operation control, NOC, functionality of a communication network. The automated solution may monitor and control a whole communication network or parts of it.

As operational load and network complexity increase due to increasing number of cells and base stations automated monitoring and control is clearly beneficial. A sleeping cell situation causes degraded user experience as data transmission does not work properly. The situation may nevertheless go unnoticed for a long period of time as a sleeping cell does not trigger conventional alarms of communication networks. The reason for not triggering conventional alarms is that calls and text messages may operate normally in a sleeping cell and/or data transmission may operate normally in one direction, but the opposite direction fails. On the other hand, simple indication of non-existing data traffic does not always imply a sleeping cell. It is possible that there are no users that would use data traffic. Thus, automatic detection of sleeping cells is not a straightforward task.

In an embodiment of the present disclosure, various performance indicator values of communication network are monitored by an automated monitoring and control system. In general, communication networks provide a large amount of performance indicator values such as counter values and/or Key Performance Indicator, KPI, values. In an example implementation, the performance indicator values are observed over a predefined time.

FIG. 1 shows an example scenario according to an embodiment. The scenario shows a communication network 101 comprising a plurality of base stations and cells, and an automated monitoring and control system 111. Performance indicator values related to the base stations and cells of the communication network 101 are conveyed to the automated monitoring and control system 111 in phase 11.

The automated monitoring and control system 111 analyses the performance indicator values in 12 to automatically determine if there are sleeping cells and to decide on actions to be taken. The automatically decided actions are performed on one or more devices (e.g. base stations and cells) of the communication network 101 in phase 13. It is to be noted that the action is decided and performed autonomously without human interaction. Furthermore, it is to be noted that the automated action is usually applied on the cell determined to be a sleeping cell, but other actions may be taken, too. The automatically decided action may be for example generation of a ticket for manual action. In this case human actions may be used for solving the issue.

The shown process is continuously repeated. Additionally, if certain cell remains a sleeping cell after an action has been taken, another, different action is usually performed.

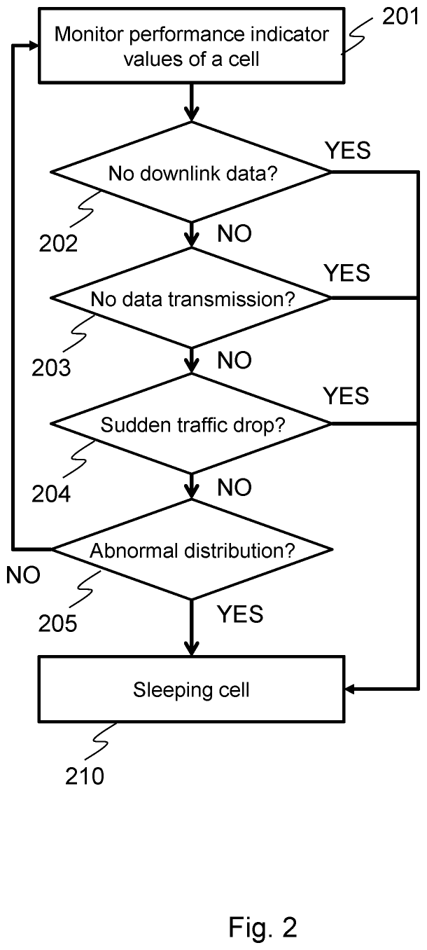

FIGS. 2-4 show flow diagrams illustrating example methods according to certain embodiments. The methods may be implemented in the automated monitoring and control system 111 of FIG. 1. The methods are implemented in a computer and do not require human interaction. It is to be noted that the methods may however provide output that may be further processed by humans. The methods of FIGS. 2-4 may be combined with each other and the order of phases conducted in each method may be changed expect where otherwise explicitly defined. Furthermore, it is to be noted that performing all phases of the flow charts is not mandatory.

FIG. 2 shows a flow diagram illustrating a method according to an embodiment of the present disclosure. The method concerns detection of sleeping cells. The method comprises following phases:

Phase 201: Performance indicator values of a cell are monitored. Only one cell is considered here, but it is clear that, correspondingly, a plurality of cells may be monitored at the same time by a computer.

Phase 202: No downlink data event is checked for. The no downlink data event is detected if it is detected that data is being transmitted in uplink direction in the cell and no data is being transmitted in downlink direction in the cell. If the no downlink data event is detected, it is determined that the cell is a sleeping cell in phase 210. Otherwise the monitoring continues in phase 203.

Phase 203: No data transmission event is checked for. The no data transmission event is detected if it is detected that there exist requests to open data connections in the cell and that no data is being transmitted in uplink or downlink direction in the cell. If the no data transmission event is detected, it is determined that the cell is a sleeping cell in phase 210. Otherwise the monitoring continues in phase 204.

Phase 204: Sudden traffic drop event is checked for. The sudden traffic drop event is detected if it is detected that the cell is up but there is a sudden decrease in the amount of data traffic in the cell. That is, the cell appears to operate normally, but a significant drop in the amount of data traffic is detected. For example, the following may be considered to indicate a significant drop: the amount of daily traffic is monitored during consecutive days and in general there is data traffic every day and then the amount of traffic drops to zero from previous days. Additionally, it may be required that the traffic in the cell is associated with more than one user. In this way, changes in behavior of only one user do not affect the process. If the sudden traffic drop event is detected, it is determined that the cell is a sleeping cell in phase 210. Otherwise the monitoring continues in phase 205.

Phase 205: Abnormal distribution event is checked for. The abnormal distribution event is detected if it is detected data traffic distribution between uplink and downlink directions is abnormal. There may be for example significantly larger amount of data traffic in uplink direction than in downlink direction. The significantly larger amount may be for example over 60-100% (e.g. over 75% or over 90%) more uplink data than downlink data. Additionally, it may be required that the traffic in the cell is associated with more than one user. In this way, changes in behavior of only one user do not affect the process. If the abnormal distribution event is detected, it is determined that the cell is a sleeping cell in phase 210. Otherwise the monitoring continues in phase 201.

It is to be noted that even though the phases 202-205 have been disclosed as consecutive process steps, the checks may be performed at least partially concurrently or in different order.

In an embodiment, the event detection in one or more of the phases 202-205 may require that the corresponding conditions are met more than once over a predefined period of time (e.g. during one day). It may be required that the number of times the conditions are met exceeds a predefined threshold. For example, at least 2, 3, 5 or 10 times may be required. In this way a random temporary failure in operation is not interpreted as detection of the associated event.

In an embodiment, determining that the cell is a sleeping cell in phase 210 may require that the event detected in one of the phases 202-205 is detected more than once over a predefined period of time (e.g. over 3-5 days, or one or two weeks). It may be required that the number of detected events exceeds a predefined threshold. For example, at least 2, 3, 5 or 10 detected events may be required. In this way a random temporary failure in operation is not interpreted as a sleeping cell situation.

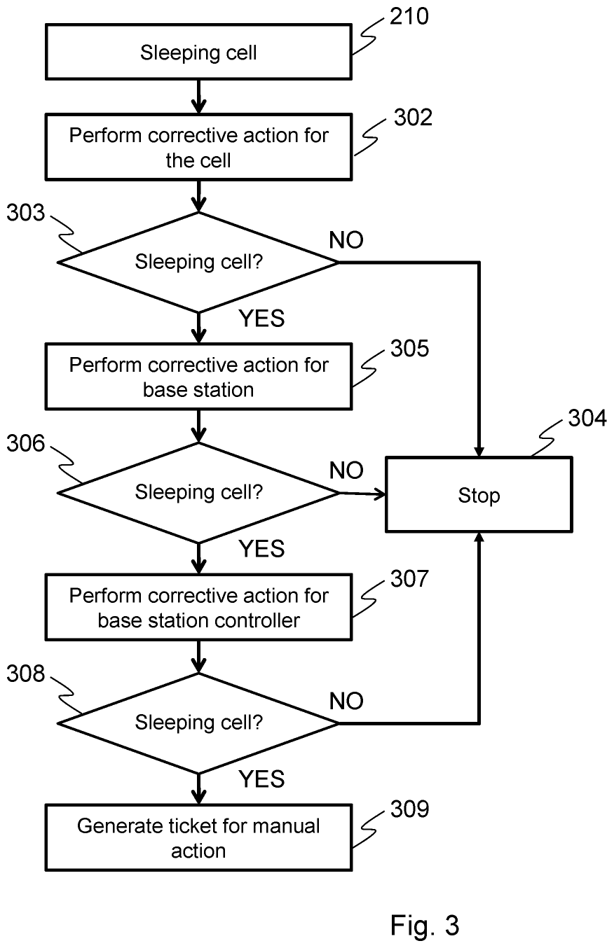

FIG. 3 shows a flow diagram illustrating a method according to an embodiment of the present disclosure. The method concerns automatic recovery from the sleeping cell situation. The method comprises following phases:

Phase 210: It is determined that a cell is a sleeping cell.

Phase 302: A corrective action is performed for the cell. The corrective action may comprise one or more of the following: deactivation and reactivation of data transmission in the cell; resetting software in the cell; resetting one or more components of the cell; resetting the whole cell.

Phase 303: It is checked if the cell remains a sleeping cell. This may be performed after a predefined time period after taking the action in phase 302. If it is concluded that the cell is no longer determined to be a sleeping cell, the process stops in phase 304. Otherwise the process proceeds to phase 305.

Phase 305: A corrective action is performed for a base station comprising the cell. The corrective action may comprise one or more of the following: deactivation and reactivation of data transmission in the base station; resetting software in the base station; resetting one or more components of the base station; resetting the whole base station.

Phase 306: It is checked if the cell remains a sleeping cell. This may be performed after a predefined time period after taking the action in phase 305. If it is concluded that the cell is no longer determined to be a sleeping cell, the process stops in phase 304. Otherwise the process proceeds to phase 307.

Phase 307: A corrective action is performed for a base station controller controlling the cell. The corrective action may comprise for example switchover to packet control unit, PCU. Instead of or in addition to performing the corrective action in the base station controller, the corrective action of this phase may be performed in some other network element that may affect operation of the cell.

Phase 308: It is checked if the cell remains a sleeping cell. This may be performed after a predefined time period after taking the action in phase 307. If it is concluded that the cell is no longer determined to be a sleeping cell, the process stops in phase 304. Otherwise the process proceeds to phase 309.

Phase 309: A ticket is generated for manual action. In this way maintenance personnel will be prompted to investigate the problem in the cell after the automatic recovery actions have not solved the situation.

It is to be noted that some phases of FIG. 3 may be left out of the process. For example, the corrective actions of phase 307 are such that they may affect large number of other cells, too. Therefore, one may want to avoid them and go directly to generating a ticket for manual handling.

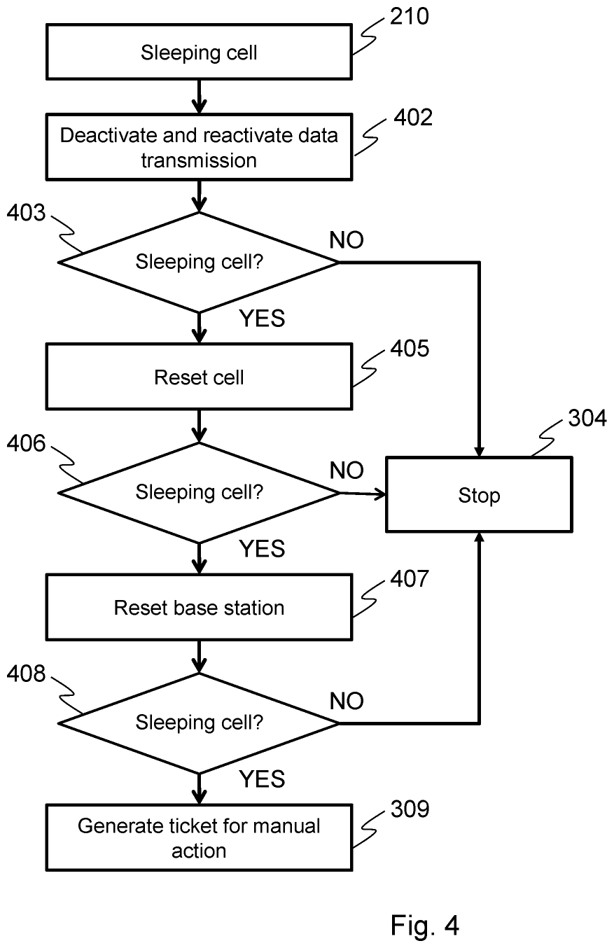

FIG. 4 shows a flow diagram illustrating a method according to an embodiment of the present disclosure. The method concerns automatic recovery from the sleeping cell situation. The method comprises following phases:

Phase 210: It is determined that a cell is a sleeping cell.

Phase 402: Data transmission functionality is deactivated and reactivated in the cell. This may be performed for example by deactivating and reactivating a GPRS (General Packet Radio Service) parameter.

Phase 403: It is checked if the cell remains a sleeping cell. This may be performed after a predefined time period after phase 402. If it is concluded that the cell is no longer determined to be a sleeping cell, the process stops in phase 304. Otherwise the process proceeds to phase 405.

Phase 405: The cell is reset.

Phase 406: It is checked if the cell remains a sleeping cell. This may be performed after a predefined time period after phase 405. If it is concluded that the cell is no longer determined to be a sleeping cell, the process stops in phase 304. Otherwise the process proceeds to phase 407.

Phase 407: A base station comprising the cell is reset.

Phase 408: It is checked if the cell remains a sleeping cell. This may be performed after a predefined time period after phase 407. If it is concluded that the cell is no longer determined to be a sleeping cell, the process stops in phase 304. Otherwise the process proceeds to phase 409.

Phase 309: A ticket is generated for manual action. In this way maintenance personnel will be prompted to investigate the problem in the cell after the automatic recovery actions have not solved the situation.

Methods of both FIGS. 3 and 4 provide that the corrective actions start from smaller scale actions and if they do not solve the situation, larger scale actions are taken into use. In this way, one achieves that disturbance to other parts of the communication network is minimized. It is to be noted that FIGS. 3 and 4 show example sequences of corrective actions. Other embodiments may comprise different sequences of corrective actions.

The predefined time after which it is checked if the cell remains sleeping cell in phases 303, 306, 308, 403, 406 and 408 of FIGS. 3 and 4 may be for example 1-5 days, or one or two weeks. The predefined time may be the same in different phases or it may vary depending on the action that was taken and/or depending on the device where the action was taken.

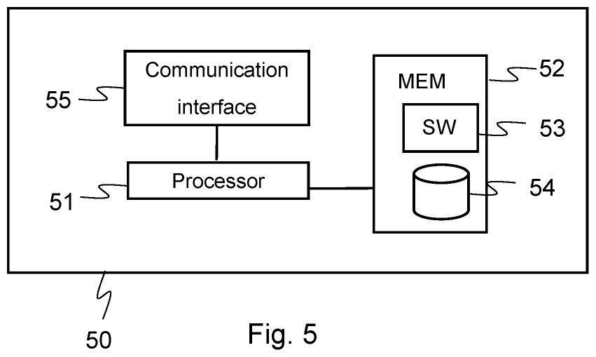

FIG. 5 shows an apparatus 50 according to an embodiment. The apparatus 50 is for example a general-purpose computer or server or some other electronic data processing apparatus. The apparatus 50 can be used for implementing embodiments of the present disclosure. That is, with suitable configuration the apparatus 50 is suited for operating for example as the communication network monitoring and control system 111 of foregoing disclosure.

The general structure of the apparatus 50 comprises a processor 51, and a memory 52 coupled to the processor 51. The apparatus 50 further comprises software 53 and database 54 stored in the memory 52 and operable to be loaded into and executed in the processor 51. The software 53 may comprise one or more software modules and can be in the form of a computer program product. The database 54 may be usable for storing e.g. data needed in the apparatus. Further, the apparatus 50 comprises a communication interface 55 coupled to the processor 51.

The processor 51 may comprise, e.g., a central processing unit (CPU), a microprocessor, a digital signal processor (DSP), a graphics processing unit, or the like. FIG. 5 shows one processor 51, but the apparatus 50 may comprise a plurality of processors.

The memory 52 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 50 may comprise a plurality of memories.

The communication interface 55 may comprise communication modules that implement data transmission to and from the apparatus 50. The communication modules may comprise, e.g., a wireless or a wired interface module. The wireless interface may comprise such as a WLAN, Bluetooth, infrared (IR), radio frequency identification (RF ID), GSM/GPRS, CDMA, WCDMA, LTE (Long Term Evolution), or 5G radio module. The wired interface may comprise such as Ethernet or universal serial bus (USB), for example. Further the apparatus 50 may comprise a user interface (not shown) for providing interaction with a user of the apparatus. The user interface may comprise a display and a keyboard, for example. The user interaction may be implemented through the communication interface 55, too.

The database 54 may be certain memory area in the memory 52 or alternatively the database 54 may be a separate component or the database 54 may be located in a physically separate database server that is accessed for example through the communication unit 55. The database unit 54 may be a relational (SQL) or a non-relational (NoSQL) database.

A skilled person appreciates that in addition to the elements shown in FIG. 5, the apparatus 50 may comprise other elements, displays, as well as additional circuitry such as memory chips, application-specific integrated circuits (ASIC), other processing circuitry for specific purposes and the like. Further, it is noted that only one apparatus is shown in FIG. 5, but the embodiments of the present disclosure may equally be implemented in a cluster of shown apparatuses.

Without in any way limiting the scope, interpretation, or application of the claims appearing below, a technical effect of one or more of the example embodiments disclosed herein is ability to automate network monitoring and control and sleeping cell detection in telecommunication networks.

Another technical effect of one or more of the example embodiments disclosed herein is that sleeping cell detection and optionally also automatic recovery can be implemented without requiring changes in user equipment. Additionally, the sleeping cell detection can be taken into use in existing network setups without network changes as the embodiments employ performance indicators readily available in network setups.

Another technical effect of one or more of the example embodiments disclosed herein is ability to detect sleeping cell situations that may otherwise go unnoticed. Yet another technical effect of one or more of the example embodiments disclosed herein is ability to recover from sleeping cell situations prior to large degradation in user experiences as the sleeping cell situations can be detected systematically and many times also recovered by automated actions.

If desired, the different functions discussed herein may be performed in a different order and/or concurrently with each other. Furthermore, if desired, one or more of the before-described functions may be optional or may be combined.

Although various aspects of the disclosed embodiments are set out in the independent claims, other aspects of the disclosed embodiments comprise other combinations of features from the described embodiments and/or the dependent claims with the features of the independent claims, and not solely the combinations explicitly set out in the claims.

It is also noted herein that while the foregoing describes example embodiments of the present disclosure, these descriptions should not be viewed in a limiting sense. Rather, there are several variations and modifications, which may be made without departing from the scope of the present disclosure as defined in the appended claims.

1. A computer implemented method of sleeping cell detection in a communication network, the method comprising
monitoring performance indicator values of cells of the communication network;
detecting one or more of the following events in a cell:
no downlink data event, wherein it is detected that data is being transmitted in uplink direction and no data is being transmitted in downlink direction,
no data transmission event, wherein requests to open data connections are detected and it is detected that no data is being transmitted in uplink or downlink direction,
sudden traffic drop event, wherein it is detected that there is a sudden decrease in the amount of data traffic in the cell, and
abnormal distribution event, wherein it is detected that data traffic distribution between uplink and downlink directions is abnormal; and
responsively determining that the cell is a sleeping cell.

2. The method of claim 1, wherein said determination of the cell being a sleeping cell requires that number of detected events exceeds a predefined threshold.

3. The method of claim 1, further comprising
responsive to the cell being determined a sleeping cell, performing a corrective action for the cell.

4. The method of claim 3, further comprising
detecting that the cell remains a sleeping cell after the corrective action being performed for the cell, and
responsively performing a corrective action for a base station comprising the cell.

5. The method of claim 4, further comprising
detecting that the cell remains a sleeping cell after the corrective action being performed for the base station, and
responsively performing a corrective action for a base station controller of the cell.

6. The method of claim 3, wherein said corrective action comprises one or more of the following: deactivation and reactivation of data transmission in the cell or in the base station; resetting software in the cell or in the base station; resetting one or more components of the cell or the base station; resetting the whole cell or the whole base station.

7. The method of claim 3, further comprising
detecting that the cell remains a sleeping cell after one or more corrective actions, and
responsively generating a ticket for manual action.

8. The method of claim 1, further comprising
responsive to the cell being determined a sleeping cell, deactivating and reactivating data transmission.

9. The method of claim 8, further comprising
detecting that the cell remains a sleeping cell after the deactivation and reactivation of data transmission, and
responsively resetting one or more components of the cell or the base station comprising the cell.

10. The method of claim 9, further comprising
detecting that the cell remains a sleeping cell after resetting the one or more components, and
responsively resetting the whole cell or the whole base station.

11. The method of claim 10, further comprising
detecting that the cell remains a sleeping cell after resetting the whole cell or the whole base station, and
responsively generating a ticket for manual action.

12. An apparatus comprising
a processor, and
a memory including computer program code; the memory and the computer program code configured to, with the processor, cause the apparatus to monitor performance indicator values of cells of the communication network; to detect one or more of the following events in a cell;
no downlink data event, wherein it is detected that data is being transmitted in uplink direction and no data is being transmitted in downlink direction,
no data transmission event, wherein requests to open data connections are detected and it is detected that no data is being transmitted in uplink or downlink direction,
sudden traffic drop event, wherein it ies detected that there is a sudden decrease in the amount of data traffic in the cell, and
abnormal distribution event, wherein it is detected that data traffic distribution between uplink and downlink directions is abnormal; and
responsively to determine that the cell is a sleeping cell.

13. (canceled)

14. The apparatus of claim 12, wherein said determination of the cell being a sleeping cell requires that number of detected events exceeds a predefined threshold.

15. The apparatus of claim 12, wherein the memory and the computer program code are further configured to, with the processor, cause the apparatus to responsive to the cell being determined a sleeping cell, perform a corrective action for the cell.

16. The apparatus of claim 12, wherein the memory and the computer program code are further configured to, with the processor, cause the apparatus to responsive to the cell being determined a sleeping cell, deactivate and reactivate data transmission.

17. The apparatus of claim 15, wherein the memory and the computer program code are further configured to, with the processor, cause the apparatus to detect that the cell remains a sleeping cell after one or more corrective actions, and responsively generate a ticket for manual action.

18. A computer program comprising computer executable program code which, when executed by a processor, causes an apparatus to perform
monitoring performance indicator values of cells of the communication network;
detecting one or more of the following events in a cell:
no downlink data event, wherein it is detected that data is being transmitted in uplink direction and no data is being transmitted in downlink direction,
no data transmission event, wherein requests to open data connections are detected and it is detected that no data is being transmitted in uplink or downlink direction,
sudden traffic drop event, wherein it is detected that there is a sudden decrease in the amount of data traffic in the cell, and
abnormal distribution event, wherein it is detected that data traffic distribution between uplink and downlink directions is abnormal; and
responsively determining that the cell is a sleeping cell.
